(19) United States
(12) Patent Application Publication
(10) Pub. No.: US 2016/0308297 A1
(43) Pub. Date: Oct. 20, 2016

(54) SPRING CONNECTOR

(71) Applicant: YOKOWO CO., LTD., Tokyo (JP)

(72) Inventor: Kenichi SATO, Kita-ku, Tokyo (JP)

(73) Assignee: YOKOWO CO., LTD., Kita-ku, TK (JP)

(21) Appl. No.: 14/916,243

(22) PCT Filed: Aug. 20, 2014
(86) PCT No.: PCT/JP2014/071801

§ 371 Date: May 27, 2016

(30) Foreign Application Priority Data
Sep. 18, 2013 (JP) 2013-192570

(51) Int. Cl. H01R 13/24; H01R 43/28

(52) U.S. Cl. CPC H01R 13/2421; H01R 43/28

(57) ABSTRACT

A spring connector includes a plunger; a contact member; and a spring for urging the plunger and the contact member so as to separate the plunger and the contact member from each other. The spring is an insulation coated metallic wire which is molded into a coil-like shape. Metal is exposed from both end faces of the insulation coated metallic wire, and at least one end part of the spring is bent inward.

### TECHNICAL FIELD

The present invention relates to a spring connector which is used for electrical connection.

### BACKGROUND ART

Generally, a spring connector includes a plunger and a contact member (for example, a pin and a tube), and a spring. The spring connector is mainly used for connection with a charging terminal of an electronic apparatus or for internal connection. With a recent tendency of increasing functions of mobile devices and tablet terminals, a value of an electric current which is supplied to the connector tends to be increased. Even though the value of the electric current to be supplied to the apparatus is increased, there is no problem in case where the apparatus is used in normal state, that is, in case where the plunger and the contact member are always kept in contact with each other. On the other hand, in case where a vibration or a mechanical shock is applied to the apparatus, it is concerned that the contact between the plunger and the contact member is interrupted, although for a very short time, and a high electric current may directly flow to a discrete spring. In case where the high electric current flows through the spring which is not positively intended to be a conductive path, Joule's heat is generated by electrical resistance of material for the spring, and in some cases, an amount of the generated heat exceeds the heat resisting temperature of the material, depending on the value or an input time of the current, causing burnout of the spring. In such circumstances, elasticity of the spring is lost, and a contact pressure against a counter side contact is remarkably lowered, and accordingly, functions as the connector are lost. Conventionally, as a countermeasure for preventing electrical connection with the spring, an insulation material is provided between the plunger and the spring, or an insulation coating is applied to the spring which has been molded into a coil-like shape.

### PRIOR ART DOCUMENT

### Patent Document

Patent Document 1: JP-A-H10-40990

Patent Document 2: JP-A-H11-174084

### SUMMARY OF THE INVENTION

### Problems that the Invention is to Solve

In a structure where the insulation material is provided between the plunger and the spring, there has been such problems that a cost is increased due to an increase of components in number, and that the insulation material must be separately provided, which is detrimental in making the connector compact and in reducing its height. On the other hand, in case where the insulation coating is applied to the spring which has been previously molded into the coil-like shape, a load characteristic of the spring (spring constant or so) are varied due to the coating. Therefore, it is difficult to finally obtain a desired spring characteristic, and the load characteristic of the spring connector is likely to be varied. In this connection, in case where a wire material which has been previously coated with an insulation material (an insulation coated metallic wire) is molded into a coil-like shape, it is possible to adjust the load during a process for molding the coil, and therefore, variation of the load characteristic can be suppressed. However, in this case, metal is exposed from cutting planes (both end faces) of the insulation coated metallic wire. Accordingly, there is such anxiety that the metal which is exposed from the both end faces is brought into contact with the plunger or the contact member by a vibration or a mechanical shock, and the high electric current may flow directly to the discrete spring, as described above.

The present invention has been made in view of the above described circumstances, and an object of the invention is to provide a spring connector in which direct flow of high electric current to a discrete spring can be prevented, although the spring is formed of an insulation coated metallic wire having metal exposed from both end faces of the insulation coated metallic wire.

### Means for Solving the Problems

An aspect of the present invention is a spring connector including a plunger, a contact member, and a spring for urging the plunger and the contact member so as to separate the plunger and the contact member from each other, wherein the spring is an insulation coated metallic wire which is molded into a coil-like shape, metal is exposed from both end faces of the insulation coated metallic wire, and at least one end part of the spring is bent inward.

The spring may be formed by cutting the insulation coated metallic wire which has been molded into the coil-like shape.

An end face which is included in one end part of the spring may be positioned inside by a distance equal to or larger than a wire diameter of the insulation coated metallic wire.

The contact member may be an electrically conductive tube which contains the spring, and the plunger may be in contact with an inner side face of the electrically conductive tube, and be protruded from one end of the electrically conductive tube.

The spring connector may include an electrically conductive tube which contains the spring, the plunger may be in contact with an inner side face of the electrically conductive tube, and be protruded from one end of the electrically conductive tube, and the contact member may be in contact with the inner side face of the electrically conductive tube, be protruded from the other end of the electrically conductive tube.

It is to be noted that desired combinations of the above described constituent elements, and descriptions of the present invention which are converted between methods and systems are also deemed effective as features of the invention.

### Advantage of the Invention

According to the present invention, it is possible to provide a spring connector in which direct flow of high electric current to a discrete spring can be prevented, while the spring is formed of an insulation coated metallic wire having metal exposed from both end faces of the insulation coated metallic wire.

### BRIEF DESCRIPTION OF THE DRAWINGS

FIG. 1 is a sectional view of a spring connector according to Embodiment 1 of the invention.

FIG. 2 is a first perspective view of a spring 3 in FIG. 1.

FIG. 3 is a second perspective view of the spring 3 in FIG. 1.

FIG. 4 is an enlarged view of an end part of the spring 3 in FIG. 1.

FIG. 5 is an enlarged view of the end part showing a coating structure of the spring 3 in FIG. 1.

FIG. 6 is a sectional view of the spring 3 in FIG. 1.

FIG. 7 is a sectional view of an essential part of the spring 3 in which a bending amount of the end part is smaller, as compared with the spring 3 in FIG. 6.

FIG. 8 is a sectional view of a spring connector according to Embodiment 2 of the invention.

FIG. 9 is a sectional view of a spring connector according to Embodiment 3 of the invention.

### MODE FOR CARRYING OUT THE INVENTION

Now, preferred embodiments of the invention will be described in detail, referring to the drawings. It is to be noted that the same or equivalent constituent elements and members which are shown in the respective drawings will be denoted with the same reference numerals, and overlapped descriptions will be appropriately omitted. Moreover, the invention is not limited to the embodiments, but the embodiments simply exemplify the invention. All the features which are described in the embodiments and combinations of the features are not absolutely essential to the invention.

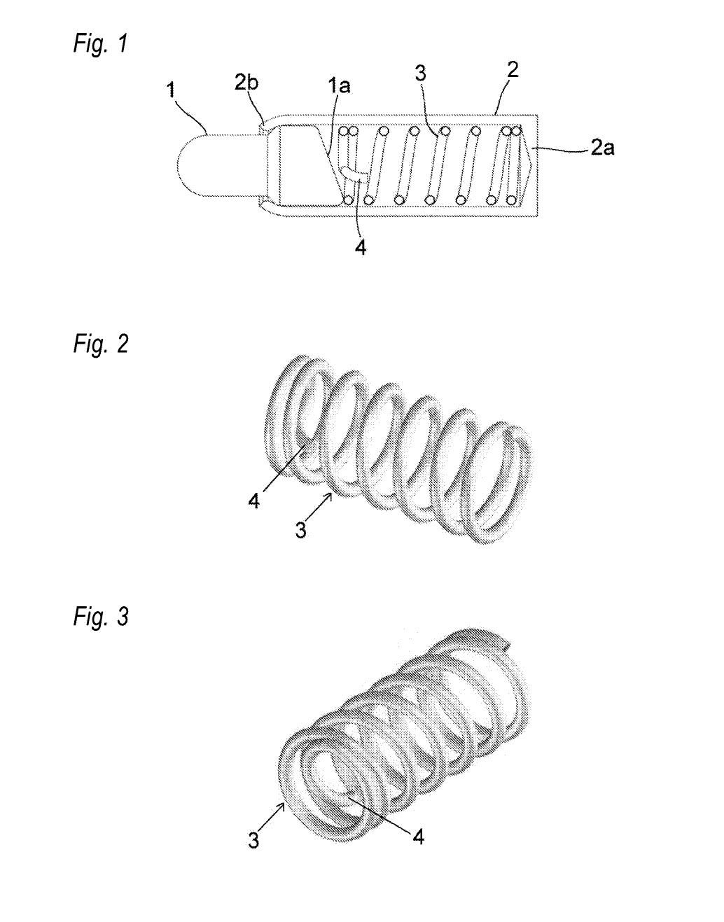

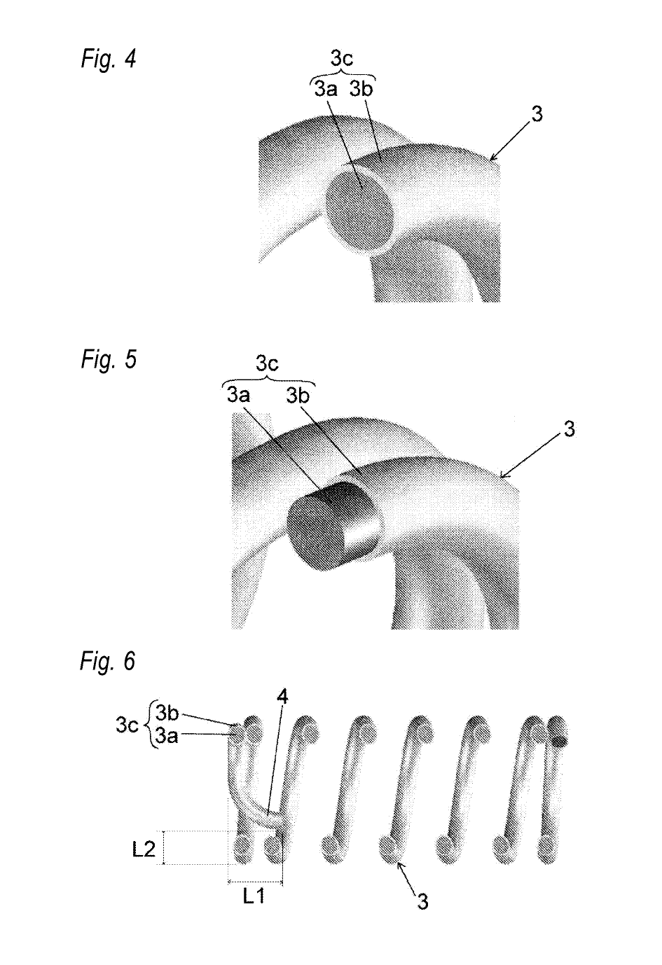

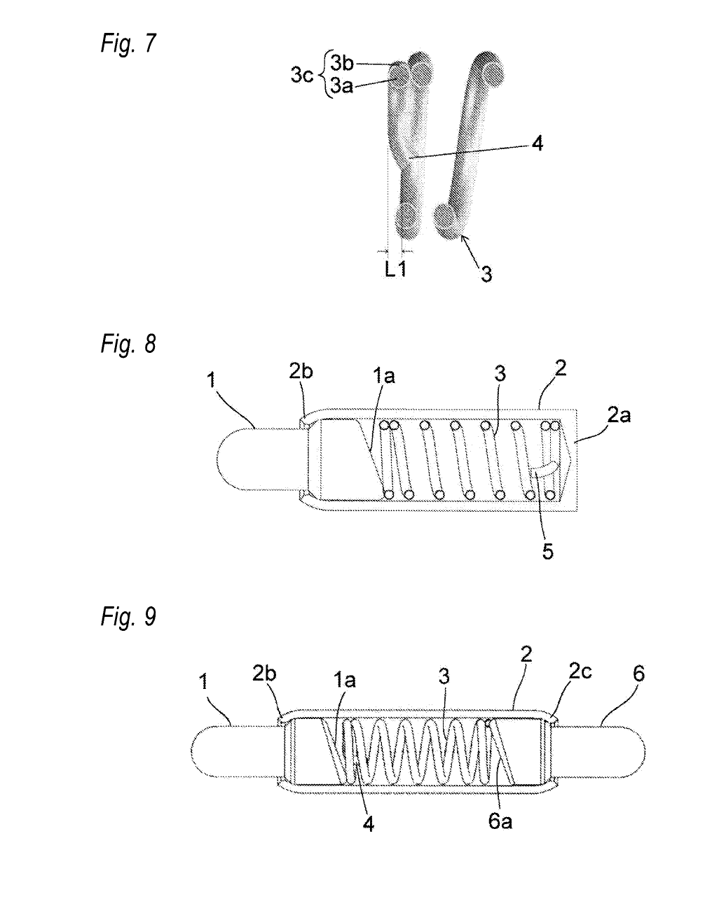

FIG. 1 is a sectional view of a spring connector according to Embodiment 1 of the invention. FIG. 2 is a first perspective view of a spring 3 in FIG. 1. FIG. 3 is a second perspective view of the spring 3 in FIG. 1. FIG. 4 is an enlarged view of an end part of the spring 3 in FIG. 1. FIG. 5 is an enlarged view of the end part showing a coating structure of the spring 3 in FIG. 1. FIG. 6 is a sectional view of the spring 3 in FIG. 1. FIG. 7 is a sectional view of an essential part of the spring 3 in which a bending amount of the end part is smaller, as compared with the spring 3 in FIG. 6.

As shown in FIG. 1, the spring connector in this embodiment includes a contact pin 1 as a plunger, an electrically conductive tube 2 as a contact member, and a spring 3. Both the contact pin 1 and the electrically conductive tube 2 are electrically conductive metallic bodies formed of copper, copper alloy or the like. The spring 3 includes an insulation coated metallic wire 3c which is obtained by applying an insulation coating 3b to a general metallic wire material 3a such as a piano wire, a stainless wire, and molded into a coil-like shape, as shown in FIGS. 4 and 5. The insulation coating 3b is material such as polyamide or polyamideimide which is used, for example, as an insulation coating for an enamel wire, and applied to the metallic wire material 3a in advance before it is molded into a coil-like shape, in the same manner as the insulation coating for the enamel wire. Accordingly, it is possible to form the insulation coating 3b at a uniform thickness on a surface of the metallic wire material 3a. The insulation coated metallic wire 3c is molded into the coil-like shape by a winding machine, and cut into individual pieces. Therefore, the metallic wire material 3a is exposed from cutting planes, namely, both end faces of the insulation coated metallic wire 3c which composes the spring 3.

The contact pin 1 is slidably held in the electrically conductive tube 2, and is in contact with an inner side face of the electrically conductive tube 2, while a distal end of the contact pin 1 is protruded from the electrically conductive tube 2. The electrically conductive tube 2 contains the spring 3. The spring 3 is provided between a base end face 1a of the contact pin 1 and a bottom 2a of the electrically conductive tube 2, and urges the contact pin 1 and the electrically conductive tube 2 so as to separate them from each other. The contact pin 1 is retained (locked) by a crimped part 2b (lock part) of the electrically conductive tube 2. The base end face 1a of the contact pin 1 is formed as a biased face which is inclined with respect to an axis, and therefore, a side pressure for pressing the contact pin 1 against the inner side face of the electrically conductive tube 2 is generated by an urging force of the spring 3. This side pressure enables the contact between the contact pin 1 and the electrically conductive tube 2 to be reliably performed. It is to be noted that the base end face 1a of the contact pin 1 may be perpendicular to the axis.

As shown in FIGS. 1 to 3 and FIG. 6, an end part 4 of the spring 3 at a side of the contact pin 1 is bent inward, and an end face which is included in the end part 4 of the spring 3 enters inward of the spring 3 both in a radial direction and in an axial direction of the spring 3. In this manner, it is possible to prevent the metallic wire material 3a which is exposed from the end face from coming into contact with the contact pin 1 and the electrically conductive tube 2 due to a vibration or a mechanical shock. In order to more reliably prevent the contact, it is desirable that a distance L1 (FIG. 6) to the end face included in the end part 4 of the spring 3 from the end of the spring 3 in the axial direction, and a distance L2 (FIG. 6) to the end face included in the end part 4 of the spring 3 from an end of the spring 3 in the radial direction are equal to or larger than an outer diameter of a single piece of the insulation coated metallic wire 3c. Moreover, it would be preferable that the end face included in the end part 4 of the spring 3 is substantially perpendicular to the axial direction of the spring 3, as shown in FIG. 6. In this regard, it is also possible to bend the end part 4 of the spring 3 inward, within such a range that the above described conditions are not satisfied. In an example in FIG. 7, the distance L1 to the end face included in the end part 4 of the spring 3 from the end of the spring 3 in the axial direction is smaller than the outer diameter of a single piece of the insulation coated metallic wire 3c, and the end face included in the end part 4 of the spring 3 is not perpendicular to the axial direction of the spring 3. Even though the end part 4 is bent in this manner, it is possible to reduce such a risk that the metallic wire material 3a which is exposed from the end face included in the end part 4 may come into contact with the contact pin 1 and the electrically conductive tube 2 by a vibration or a mechanical shock. The end part 4 of the spring 3 should be bent, before the insulation coated metallic wire 3c is molded into the coil-like shape. It is to be noted that an end part of the spring 3 at an opposite side to the contact pin 1 may also be bent inward, in the same manner as the end part 4 at the side of the contact pin 1.

According to this embodiment, the following advantages can be obtained.

(1) Since the end part 4 of the spring 3 is bent inward, the end face included in the end part 4 enters inside the spring 3, and therefore, it is possible to reduce such a risk that the metallic wire material 3a which is exposed from the end face may come into contact with the contact pin 1 and the electrically conductive tube 2 by a vibration or a mechanical shock. For this reason, even in case where the contact between the contact pin 1 and the electrically conductive tube 2 is momentarily interrupted by a vibration or a mechanical shock, direct flow of the high electric current to the discrete spring 3 can be prevented, and it is possible to reduce a risk of burnout of the spring 3.

(2) Since the metallic wire material 3a covered with the insulation coating 3b (the insulation coated metallic wire 3c) is molded into the coil-like shape, there is no necessity of applying the insulation coating, after a winding work has been performed by a winding machine, setting a desired load at a time of molding. Therefore, it is possible to stably realize a desired spring characteristic (expanding and contracting performance of the spring connector). That is, in case where the insulation coating is applied (for example, by spray coating) after the metallic wire material 3a has been molded into the coil-like shape, the spring characteristics (spring constant, etc.) are varied, and it is difficult to obtain desired spring characteristics. However, according to this embodiment, it is possible to favorably solve the above described problem.

(3) The insulation coating 3b is formed on the metallic wire material 3a continuously along a length corresponding to a large number of the springs 3. Therefore, by molding the springs 3 using this insulation coated metallic wire 3c, it is possible to produce a large number of the springs 3 at a low cost. Moreover, the insulation coating 3b is generally a coating including several layers which are laminated, and provides high heat resistance and mechanical strength.

FIG. 8 is a sectional view of a spring connector according to Embodiment 2 of the invention. This spring connector 3 is different from the spring connector in Embodiment 1 in that an end part 5 of the spring 3 at an opposite side to the contact pin 1 is bent inward (an end part of the spring 3 at a side of the contact pin 1 is not bent). The end part 5 may be bent in the same manner as the end part 4 as shown in Embodiment 1. Other features in the present embodiment are substantially the same as those in Embodiment 1. The features in this embodiment can achieve substantially the same effects as those in Embodiment 1 as well.

FIG. 9 is a sectional view of a spring connector according to Embodiment 3 of the invention. Different points from Embodiment 1 will be mainly described below. The spring connector in the present embodiment is provided with a contact pin 6 as a contact member, in addition to the structure in Embodiment 1 (the contact pin 6 functions as the contact member in place of the electrically conductive tube 2). The contact pin 6 has the same shape as the contact pin 1, and is formed of the same material. The contact pin 6 is slidably held in the electrically conductive tube 2, and is in contact with the inner side face of the electrically conductive tube 2, having its distal end protruded from the electrically conductive tube 2. The spring 3 is provided between the base end face 1a of the contact pin 1 and a base end face 6a of the contact pin 6, and urges the contact pins 1 and 6 so as to separate from each other. The contact pin 6 is retained (locked) by the crimped part 2c (lock part) of the electrically conductive tube 2. The end part 4 of the spring 3 at a side of the contact pin 1 is bent inward in the same manner as in Embodiment 1. Other features in the present embodiment are substantially the same as those in Embodiment 1. The features in this embodiment can achieve substantially the same effects as those in Embodiment 1 as well.

Although the invention has been heretofore described referring to the embodiments as examples, it is to be understood by those skilled in the art that various modifications can be made in the respective constituent elements and respective treating processes in the embodiments, within a scope described in the claims.

### DESCRIPTIONS OF THE REFERENCE NUMERALS AND SIGNS

1 Contact pin
2 Electrically conductive tube
3 Spring
3a Metallic wire material
3b Insulation coating
3c Insulation coated metallic wire
4 End part
6 Contact pin

1. A spring connector comprising:
a plunger;
a contact member; and
a spring for urging the plunger and the contact member so as to separate the plunger and the contact member from each other, wherein
the spring is an insulation coated metallic wire which is molded into a coil-like shape,
metal is exposed from both end faces of the insulation coated metallic wire, and
at least one end part of the spring is bent inward.

2. The spring connector according to claim 1, wherein the spring is formed by cutting the insulation coated metallic wire which has been molded into the coil-like shape.

3. The spring connector according to claim 1, wherein an end face that is included in one end part of the spring is positioned inside by a distance equal to or larger than a wire diameter of the insulation coated metallic wire.

4. The spring connector according to claim 1, wherein the contact member is an electrically conductive tube that contains the spring, and the plunger is in contact with an inner side face of the electrically conductive tube, and is protruded from one end of the electrically conductive tube.

5. The spring connector according to claim 1, comprising an electrically conductive tube that contains the spring, wherein
the plunger is in contact with an inner side face of the electrically conductive tube, and is protruded from one end of the electrically conductive tube, and
the contact member is in contact with the inner side face of the electrically conductive tube, and is protruded from the other end of the electrically conductive tube.

6. The spring connector according to claim 2, wherein the contact member is an electrically conductive tube that contains the spring, and the plunger is in contact with an inner side face of the electrically conductive tube, and is protruded from one end of the electrically conductive tube.

7. The spring connector according to claim 2, comprising an electrically conductive tube that contains the spring, wherein
the plunger is in contact with an inner side face of the electrically conductive tube, and is protruded from one end of the electrically conductive tube, and
the contact member is in contact with the inner side face of the electrically conductive tube, and is protruded from the other end of the electrically conductive tube.

8. The spring connector according to claim 3, wherein the contact member is an electrically conductive tube that contains the spring, and the plunger is in contact with an inner side face of the electrically conductive tube, and is protruded from one end of the electrically conductive tube.

9. The spring connector according to claim 3, comprising an electrically conductive tube that contains the spring, wherein
the plunger is in contact with an inner side face of the electrically conductive tube, and is protruded from one end of the electrically conductive tube, and
the contact member is in contact with the inner side face of the electrically conductive tube, and is protruded from the other end of the electrically conductive tube.

10. A method of manufacturing a spring that is applied to a spring connector and is adapted to urge a plunger and a contact member so as to separate the plunger and the contact member from each other, the method comprising:
bending an end part of an insulation coated metallic wire that is obtained by applying an insulation coating to a metallic wire material; and
molding the insulation coated metallic wire into a coil-like shape, and cutting the molded insulation coated metallic wire.
